(19) United States
(12) Patent Application Publication
(10) Pub. No.: US 2009/0045683 A1
(43) Pub. Date: Feb. 19, 2009

(54) LINEAR VARIABLE RELUCTANCE ACTUATOR HAVING BAND COILS

(75) Inventors: Johannes P. M. Vermeulen, North Strabane, PA (US); Antonius T. A. Piejnenburg, Pittsburgh, PA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/093,819

(22) PCT Filed: Nov. 14, 2006
(86) PCT No.: PCT/IB06/54251

§ 371 Date: May 15, 2008

Related U.S. Application Data
(60) Provisional application No. 60/738,240, filed on Nov. 18, 2005.

(51) Int. Cl. H02K 41/02

(52) U.S. Cl. 310/14

(57) ABSTRACT

A linear VR motor or actuator having band coils is provided. The VR actuator includes a first core dimensioned as either a single ‘E’ or a double ‘E’. Each center protruding bar may be capped with a permanent magnet made of a Ferro-magnetic material or ceramic magnetic material for preloading the actuator, which is advantageous from controllability point of view, and enables the actuator to counteract gravitational load without nominal current through the wires. The first core is also formed of a Ferro magnetic material. The spaces between the protruding bars are filled with band coils arranged parallel to the protruding bars and electrically conductive. An I-core of Ferro-magnetic material is positioned perpendicular to the protruding bars. A current induced in the band coils controllably amplifies or negates a magnetic flux produced by the permanent magnets. Different shapes (e.g. circular shapes) for the I-core (e.g. being part of a circular axis) and the opposite part of the E-core may be used.

The present disclosure relates generally to electromagnetic actuators. More specifically, the present disclosure provides a variable reluctance actuator having band coils.

Rotating variable reluctance (VR) motors, as disclosed in U.S. Pat. No. 5,866,965 and herein incorporated by reference, are generally utilized as stepper motors and if properly controlled, can be made to behave much like a servomotor. The VR motor has a rotor and a stator, however unlike other types of motors, the stator in a VR motor contains coil windings (brushless motor). The rotor, which usually consists of a laminated permeable magnetic material such as iron with teeth, is a passive component with no coil windings or permanent magnets. The stator typically consists of protrusions on which wire is wound to form a series of coils. The energization of these coils is electronically switched to generate a rotating electromagnetic field. Usually only a single coil set is energized at any given time.

When one stator coil set is on, a magnetic flux path is generated around the coil and through the rotor. The rotor experiences a torque to align with the magnetic flux lines generated by the magnetic field, minimizing the flux path. With the appropriate switching and energization of the stator coils, the rotor can be encouraged to rotate at any desired speed and torque.

This setup offers better performance than many other types of motors. A VR motor does not require sinusoidal exciting waveforms for efficient operation, so it can maintain higher torque and efficiency over broader speed ranges than is possible with other advanced variable-speed systems. The optimal waveforms needed to excite a VR motor have a high natural harmonic content, and are typically the result of a fixed voltage applied to the motor coils at predetermined rotor angles. Such waveforms can be achieved at virtually any speed.

In addition, as long as the commutation can be accurately controlled with respect to the rotor angle, the motor will operate at its predicted high efficiency. In fact, using VR technology it is possible to design a low-cost motor with over 90-percent system efficiency and variable speed at a good price.

VR motors also provide other benefits. They can be programmed to precisely match the loads they serve, and their simple, rugged construction has no expensive magnets or squirrel cages like AC induction motors. With no internal excitation or permanent magnet, the motor is inherently resistant to overload and immune to single-point failure.

These benefits remained mostly hidden following the initial use of VR motors in the opening decades of the 1800's. The motors reappeared in the early 1980's, with the development of electronic controllers for brushless motors; these same controllers could also be used for the highly nonlinear VR motors.

The United States Department of Defense has pursued VR-motor applications aggressively. The motors have been utilized in applications ranging from generators for turbine engines to pump motors for jet fighters. The technology is very attractive in applications where reliability is the top priority, not cost. For the same reason, the aerospace industry also has begun to use VR motors for applications including actuator controls for aircraft flaps.

VR motors are not without their drawbacks, however. The most significant downside is the acoustic noise and large vibrations often caused by the motor's high pulsating magnetic flux. This noise can be reduced by adding components to the electronics, designing special magnetic circuits, and tweaking the mechanical design, but taking some or all of these steps could compromise the motor's benefits. Designers generally select the right combination of noise reduction and performance to suit the particular application.

Another limitation is torque ripple. It can be difficult to give VR motors a smooth torque profile, so they are used more often in place of variable speed motors than as servomotors. There are ways to control torque ripple, such as adding encoders and electronics to compensate, but these added controls could cost at least as much as what the motor itself would save. If torque ripple is of primary concern, the best alternative might be a permanent magnet motor instead.

VR motors work with relatively small air gaps, typically smaller than 0.5 mm. If the shaft is off-center, unbalanced tangential forces come into play due to the strong non-linear behavior, so shafts and bearing systems generally need to be of a higher quality than with other motors. Various motor designers are working on designs to widen the air gap.

For not continuously rotating applications such as positioning systems or stages, linear VR motors and actuators are highly efficient compared to Lorentz motors and actuators, especially in applications with high external load (high K-factor). Lorentz motors or actuators consist of a wire coil or band coil in a magnetic field that is going through air and magnetic material (may be considered as air) for a significant portion of the flux path, and therefore, these motors or actuators are rather inefficient. In VR motors and actuators on the other hand, iron is used in both the stator and the mover (rotor) to capture the magnetic field and so, the air gap is much smaller.

As a result, energy dissipation in Lorentz motors and actuators is significantly higher compared to VR motors and actuators for an equivalent force.

Typically, coils in VR motors and actuators are made of circular copper wires having diameters on the order of between 0.25 mm and 0.5 mm. These wires are generally wound using orthocyclic-winding methods.

The orthocyclic-winding method is defined as a special winding technique for circular wires to achieve maximum filling. Instead of randomly stacking wire coils, the orthocyclic-winding method staggers the wires so that the wire of a second layer is positioned in the space formed between two wire windings of the previous level. Thus, the filling factor, defined as the ratio of the actual conducting metal of the wire to the total coil area, is theoretically maximized for circular wires.

Despite the orthocyclic-winding methods in existing wire coils, the filling factor of copper is limited because of entrapped air between the wires. For randomly stack-wound coils, a filling factor of about 0.7 is feasible and for orthocyclic-wound coils, a practical filling factor of about 0.8 is obtainable (theoretically 0.906 for a large number of turns). In addition, heat that is generated in the current conducting wires is not efficiently transferred to the environment due to the low thermal conductivity of the isolating cover of the individual wires. The thermal resistance of wires is generally a factor of 100 greater than the resistance of only metal over a given length.

The relatively high thermal resistance of conventional wire coils results in restriction of the maximum current per unit of cross sectional area, i.e., current density, for a certain duty cycle of the actuator and consequently, the maximum motor force per unit volume is restricted. This problem exists for Lorentz actuators based on current conducting wires as well.

In order to combine the efficiency of VR motors or actuators (high k-factor), with an improved maximum current density because of better thermal conductivity to a cooling body, band coils are proposed in VR motors and actuators. These band coils are fashioned from copper, aluminum, or other such material having high electrical and thermal conductance. Especially for high throughput applications (high duty cycles), a higher maximum motor force is attained.

Additionally, lower and more stable operating temperature is realized for the same actuator load or current density. The resulting lower operating temperature provides added benefits in high precision applications.

The present disclosure provides a linear VR motor or actuator comprising a first core having a plurality of bars protruding perpendicularly from a crossbar. Additionally, a permanent magnet may be positioned at a top of a central bar of the upright bars and plurality of band coils is positioned between the plurality of bars. The band coils are formed from an electrically conductive material. Further, a second core dimensioned as a bar is positioned above the upright bars.

These and other features, aspects, and advantages of the present disclosure will become better understood with regard to the following description, appended claims, and accompanying drawings wherein:

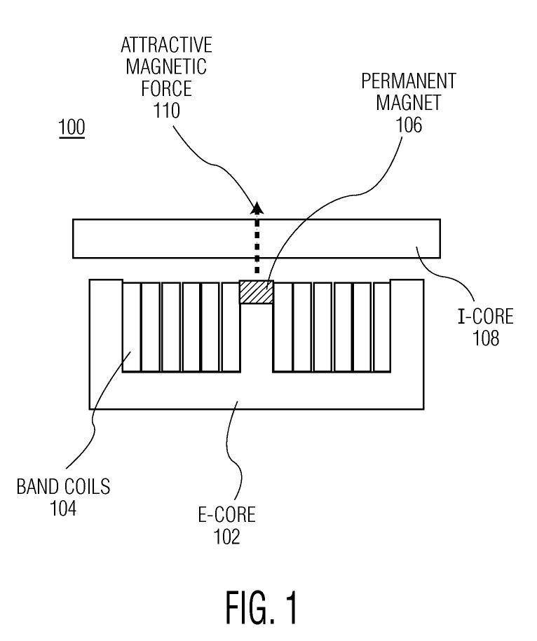

FIG. 1 is a cross-sectional representation of a single-sided linear VR actuator, in accordance with the present disclosure; and

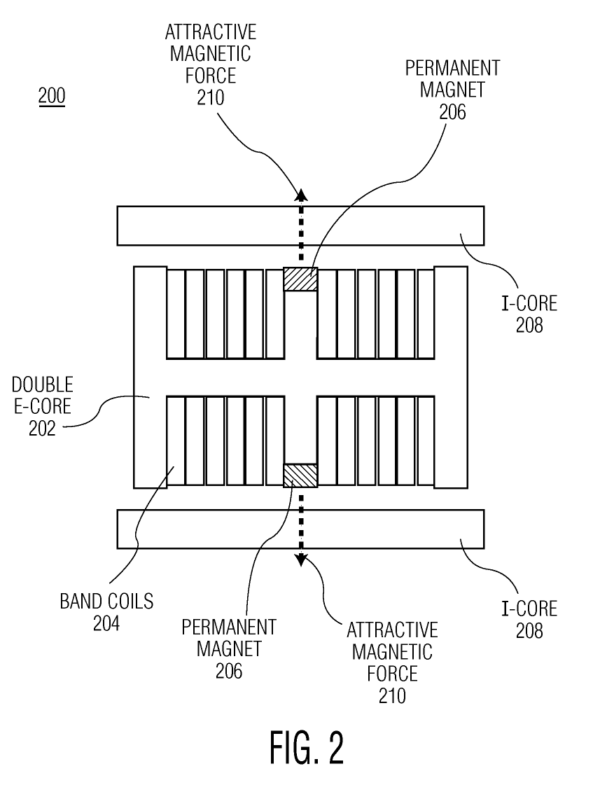

FIG. 2 is a cross-sectional representation of a dual-sided linear VR actuator, in accordance with the present disclosure.

Here, ‘linear’ refers to a translational direction of motion, essentially in the direction parallel to the flux lines, that is, basically normal forces are used to increase or decrease the gap height between stator and mover, as compared to tangential forces as used in rotary applications as described in U.S. Pat. No. 5,866,965, which are roughly orthogonal to the flux lines to align rotor tooth with the magnetic flux lines from the stator tooth, implying motion in lateral direction at constant gap.

Referring to FIG. 1, an embodiment of the present disclosure is shown. The single-sided linear VR actuator 100 of the present disclosure is constructed using an E-core 102, of steel or any other Ferro-magnetic metal or alloy can be used. The E-core, as its name implies is shaped as a capital letter ‘E’ flipped on its side. The spaces between the vertical bars of the E-core 102 are occupied by a plurality of tightly packed current conducting band coil 104. Additionally, the center vertical bar may be capped with a permanent magnet 106 made of Ferro-magnetic or ceramic-magnetic material for preloading the actuator, which is advantageous from a controllability point of view, enabling the actuator to counteract gravitational load without nominal current through the wires. Opposite the vertical bars, is positioned an I-core 108 made of steel or any Ferro-magnetic metal or alloy can be used.

In the case where the permanent magnet 106 is present, the actuator 100 induces a magnetically attractive force in the vertical direction, i.e., normal force to the I-core 108 in the direction indicated by the dashed arrow 110. Thus, at a current equal to zero, the E-core 102 is drawn upward until the gap between the E-core 102 and the I-core 108 is zero.

Application of current to the band coils 104 causes the magnetic flux from the permanent magnet 106 to be amplified or cancelled based on the direction of the current. By amplifying the magnetic flux, the E-core 102 closes the E-core/I-core gap more rapidly. However, by changing the direction of the current flow through the band coil 104, the magnetic flux is partially canceled and the E-core 102 lowers e.g. through gravitational force, thus increasing the E-core/I-core gap. The speed at which the E-core 102 moves up or down is dependent on the actual current value and direction. Therefore, by applying a control loop having a gap measuring means, as known in the art, the actuator 100 can be used as a linear positioning device in such applications as a movable stage for precision scanning.

Referring now to FIG. 2, a dual-sided VR actuator 200 is shown having a double E-core 202 in place of the single E-core 102 of the previous embodiment. While the single-sided VR actuator 100 as shown in FIG. 1 requires an additional external load, e.g. provided by gravity or another actuator from a controllability point of view, the dual-sided VR actuator 200 as shown in FIG. 2 does not need any additional external load.

The spaces between the vertical bars of the double E-core 202 are occupied by a plurality of tightly packed current conducting band coils 204. Additionally, the each center vertical bar may be capped with a permanent magnet 206 for preloading each individual actuator part, which is advantageous from controllability point of view and enables the actuator to counteract gravitational load as the difference between the upper and lower magnetic forces without nominal current through. Opposite the vertical bars at each side, is positioned an I-core 208.

In the case where the permanent magnets 206 are provided, the actuator 200 induces an attractive force in upward and downward vertical direction, i.e., a normal force to both I-cores 208 in the direction indicated by the dashed arrows 210. Depending on the strength of the two individual magnets and the vertical position, the double E-core actuator is being magnetically attracted to the I-core 208 in an upward or a downward direction. As shown, the double E-core experiences attractive forces 210 in two opposite directions such that at a current equal to zero, the double E-core 202 is centered between the two I-cores 208, where depending on the difference between the permanent magnets 206, the linear VR actuator is capable to counteract gravity forces to a stage. Varying the magnitude and direction of the current flowing through the band coils 204 biases the double E-core towards one direction or the other.

It should be noted, that while the embodiments of the present invention have been described having an I-core and either a single or a dual E-core, other shapes may be used, such as circular cores, depending on the specific application.

The described embodiments of the present invention are intended to be illustrative rather than restrictive, and are not intended to represent every embodiment of the present invention. Various modifications and variations can be made without departing from the spirit or scope of the invention, such as using different shapes (e.g. circular shapes) for the I-core (e.g. being part of a circular axis) and the opposite part of the E-core, as set forth in the following claims both literally and in equivalents recognized in law.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed devices or portions thereof may be combined together or separated into further portions unless specifically stated otherwise; and

f) no specific sequence of acts is intended to be required unless specifically indicated.

1. A linear VR motor or actuator comprising:
a first core having a plurality of bars protruding perpendicularly from a crossbar;
plurality of band coils positioned between said plurality of bars, said band coils being formed from an electrically conductive material; and
a second core dimensioned as a bar, said second core being positioned above said plurality of bars of said first core.

2. The VR actuator of claim 1, further comprising a permanent magnet positioned at a top of a central upright bar.

3. The VR actuator of claim 1, wherein said plurality of bars is three equally spaced bars.

4. The VR actuator of claim 1 wherein said plurality of bars are arranged into a first set of three bars and a second set of three bars, said second set being positioned on a side of said crossbar opposite to said first set.

5. The VR actuator of claim 1, wherein said first core and said second core are formed from Ferro-magnetic material.

6. The VR actuator of claim 1, wherein said permanent magnet is formed of a ceramic material.

7. The VR actuator of claim 1, wherein said permanent magnet is formed of a Ferro-magnetic material.

8. The VR actuator of claim 1, wherein a current is induced in said band coils such that a magnetic flux of said permanent magnet can be controllably amplified or negated.

9. A VR motor or actuator comprising:
a first core having three upright bars protruding perpendicularly from a crossbar, said upright bars being equally spaced;
plurality of band coils positioned between said plurality of upright bars, said band coils being formed from an electrically conductive material; and
a second core dimensioned as a bar, said second core being positioned above said three upright bars.

10. The VR actuator of claim 9, further comprising a permanent magnet positioned at a top of a central bar of said three upright bars.

11. The VR actuator of claim 9, wherein said first core and said second core are formed from Ferro-magnetic material.

12. The VR actuator of claim 9, wherein said permanent magnet is formed of a ceramic material.

13. The VR actuator of claim 9, wherein said permanent magnet is formed of a Ferro-magnetic material.

14. The VR actuator of claim 9, wherein a current is induced in said band coils such that a magnetic flux of said permanent magnet can be controllably amplified or negated.

15. A VR motor or actuator comprising:
a first core having a first set of bars protruding perpendicularly form a central crossbar;
a second set of bars protruding perpendicular to said central crossbar and positioned opposite to said first set of bars, said bars of said first set being equally spaced along said central crossbar and said bars of said second set being equally spaced along said central crossbar;
plurality of band coils positioned between said plurality of upright bars, said band coils being formed from an electrically conductive material;
a second core dimensioned as a bar, said second core being positioned above said first set of bars; and
a third core dimensioned as a bar, said third core being positioned above said second set of bars.

16. The VR actuator of claim 15, further comprising a first permanent magnet is positioned at a top of a central bar of the first set; and a second permanent magnet is positioned at a top of a central bar of the second set.

17. The VR actuator of claim 15, wherein said first set of bars has three equally spaced bars; and said second set bars has three equally spaced bars.

18. The VR actuator of claim 15, wherein said first core and said second core are formed from Ferro-magnetic material.

19. The VR actuator of claim 15, wherein said first and second permanent magnets are formed of one of a Ferro-magnetic material and a ceramic material.

20. The VR actuator of claim 15, wherein a current is induced in said band coils such that a magnetic flux of said first permanent magnet is controllably amplified or negated, while a magnetic flux of said second permanent magnet is oppositely affected.
